(19) United States
(12) Patent Application Publication
(10) Pub. No.: US 2005/0084949 A1
(43) Pub. Date: Apr. 21, 2005

(54) Biological filter

(75) Inventors: Zarook M. Shareefdeen, Guelph (CA); Brian P. Herner, Georgetown (CA)

Correspondence Address: FASKEN MARTINEAU DUMOULIN LLP;Toronto Dominion Bank Tower, P.O. Box 20, Toronto-Dominion Centre, Toronto, ON, M5K 1N6, CA

(73) Assignee: Biorem Technologies, Inc.

(21) Appl. No.: 10/687,761

(22) Filed: Oct. 20, 2003

(51) Int. Cl. C12S 5/00

(52) U.S. Cl. 435/266; 435/176; 435/299.1

(57) ABSTRACT

A biofilter media including grains having a hydrophilic nucleus and a hydrophobic coating, the hydrophobic coating includes microorganisms and also includes a metallic agent that both assist in the efficient breakdown of hydrogen sulfide (H₂S), other sulfur based compounds, such as reduced sulphur compounds, and both chlorinated and non-chlorinated volatile organic compounds. The metallic agent also increases efficiency during start-up of the biofilter media and in shock-loading conditions. The biofilter media is housed in a biofilter system that includes elements for the irrigation and humidification of the air stream of the biofilter media by steam or spray to ensure that the biofilter media is operating at appropriate temperature and moisture levels to avoid buildup of biomass or chemical deposits.

### FIELD OF THE INVENTION

The present invention relates to a biological filter system (“biofilter system”) used in filtration and air or gas purification and, more particularly, to a media used for biological filtering (“biofilter media”).

### BACKGROUND OF THE INVENTION

It is well known that numerous municipal and industrial operations including wastewater treatment, food processing, petrochemical refining, paper and pulp manufacturing, rendering, and composting processes produce various waste gases, including, for example, hydrogen sulfide (H₂S). H₂S is a highly odorous, toxic and corrosive air contaminant that can cause adverse health effects such as headaches, nausea, eye irritation, paralysis and even death if a person is exposed to high concentrations.

Generally speaking, the maximum safe exposure limit to H₂S gas is approximately 10 ppm, however, the gas detection threshold is approximately 0.47 ppb. Given the safe exposure limit and the fact that even small quantities can be detected, there are strict regulations in effect for controlling the emission of H₂S gas in many regions of the world.

In the following specification, the term “air contaminants” refers to chemical compounds present in waste gases and includes but is not limited to sulfur based compounds, such as hydrogen sulfide (“H₂S”), and volatile organic compounds (“VOCs”), such as chlorinated organics. Further, the term “air stream” refers to a flow of air that contains air contaminants.

In recent years, biofiltration has been widely accepted as one of the more efficient odor and air contaminant removal technologies and has replaced numerous conventional treatment processes due to its more effective, economical and environmentally friendly process when applied to dilute and biodegradable compounds.

Prior to the development of biofilters, conventional treatment methods used to remove H₂S from air streams, relied on processes such as activated carbon adsorption, chemical oxidation, and incineration. These conventional systems have drawbacks such as high equipment cost, high disposal cost, chemical requirements, and high energy cost.

A biofilter system is a basic biological reactor including media such as peat, wood bark, soil, compost, coated ceramic particles, synthetic media, or a combination of these products upon which microbial populations grow as thin biofilms. As a contaminated air stream passes through the biofilter, air contaminants such as H₂S are transported to the biofilm where they are biodegraded.

While laboratory and field studies have shown that biofiltration of air streams polluted with H₂S is feasible, there have been numerous problems reported due to the formation of acidic intermediate products, sulfur deposits within the biofilter and slow rate of uptake which results in large media volume requirements for full-scale biofilters. The intermediate products and sulfur deposits greatly reduce the efficiency of biofilter media and can also render biofilter media inoperable due to changes in pH levels. Specifically, depressed pH levels caused by the generation of acid intermediates may interfere with the removal efficiency of highly odorous reduced sulfur compounds.

Some studies have been conducted with respect to the elimination of sulfur based compounds. Allen and Yang [Allen, E. R. and Yang, Y., “Biofiltration: An Air Pollution Control Technology for Hydrogen Sulfide Emissions”, Ed. D. T. Sawyer and A. E. Martell, Industrial Environmental Chemistry, Plenum Press, NY, 1992.] reported that during two years of operation of a commercial biofilter using wood based media, pH decreased from 8.6 to 1.8. In a later study, Allen and Yang [Yang, Y. and Allen, E. R., part 1 “Biofiltration Control of Hydrogen Sulfide 1. Design and Operational Parameters, J. Air & Waste Manage. Assoc., 44, 863-868, 1994., Yang, Y. and Allen, E. R., “Biofiltration Control of Hydrogen Sulphide. 2. Kinetics, Biofilter performance and maintenance”, J. Air & Waste Manage. Assoc., 44 (November): I315-1321, 1994.], reported that sulphate accumulation after long term operation caused media colour to change from dark brown to yellowish, indicating deposits. In another study, Chung et al., [Chung, Y-C et al., “Biodegradation of Hydrogen Sulfide by a laboratory scale immobilized pseudomonas putida CH11 Biofilter”, Biotech. Progress, 12, 1996.], reported that if peat was used as a media, elemental sulfur could later be detected in the peat. In a further study, Chung et al., [Chung, Y-C et al., “Comparison of autotrophic and mixotrophic biofilters for Hydrogen Sulfide removal”, J. of Env. Engineering, April 1998.] reported that the main product found in the media was SO₄²⁻ and suggested that an increase in the oxygen level in the air stream could prevent sulphate buildup. Most recently, an article by Shareefdeen et al., (2002)[Shareefdeen et al. “Biofiltration of nuisance sulfur gaseous odors from a meat rendering plant”, J of Chemical Technology and Biotechnology, 77: 1-4, 2002], the content of which is hereby incorporated herein by reference, reported that the removal of low-level sulfur compounds is difficult within a wood-based biofilter system.

A more recent type of biofilter media is described in European Patent No. 0 497 214, issued to OTTO LUFT und KLIMATECH-NIK GmbH & Co. KG et. al., the content of which is hereby incorporated herein by reference. In this patent, the biofilter media consists of porous grains, the pores of which are used as a working surface for biologically oxidizing micro-organisms. The grains consist of a core nucleus of hydrophilic material coated with a hydrophobic material. The hydrophilic material is porous concrete, expanded clay or pumice stone and the hydrophobic material is activated carbon or adsorbing resin. Although this biofiltering media has better structural and biological properties compared to wood based media products, it still has some of the same problems noted above and, in particular, removal effectiveness for reduced sulfur compounds is still relatively low.

Industrial and municipal waste gases containing air contaminants such as H₂S sources are numerous and increasing. The cost effective and efficient removal of air contaminants will become more important in biofilter systems. Accordingly, there is a need for an improved and more efficient biofilter media and biofilter system for removing air contaminants from air streams in industry.

### SUMMARY OF THE INVENTION

It is therefore an object of the present invention to provide an improved biofilter media and biofilter system for cleaning contaminated air or waste gas by conversion and biological oxidation, and a more efficient method of removing sulfur based air contaminants such as organic sulphides and VOC's from air streams addressing at least some of the problems identified above.

According to an embodiment of the invention, there is provided a biofilter media including a plurality of grains, where each grain includes a porous hydrophilic nucleus and a hydrophobic coating on the hydrophilic nucleus, where the hydrophobic coating includes a metallic material (also called a metallic agent), microorganisms, nutrients, organic carbon, an alkaline buffer, a bonding agent, an adsorptive agent, and a hydrophobic agent. Preferably, each grain has a size of between approximately 2 and 25 (mm) millimeters.

In a particular case, the hydrophilic nucleus may include a porous low-density aggregate. In this case, the porous low density aggregate may be produced by gas expansion at temperatures exceeding 1100° C.

In a further particular case, the metallic agent includes at least one metal selected form the group of iron, manganese, nickel, copper, titanium or a similar metal from the transition element group having similar properties. In a preferred case, the metallic agent includes iron. In order to facilitate the formation of the hydrophobic coating, the metallic agent may be in powdered form.

In yet a further particular case, the adsorptive agent and the hydrophobic agent may be provided by a single material such as clinoptilolite, activated carbon or some combination thereof.

In a further particular case, the microorganisms may include microorganisms selected from Thiobacillus (T) thioparus, begigiatoa, thiothrix genera, and T. feroxidants. The microorganisms may be provided by, for example, including a natural source of microorganisms such as one or more of peat, compost or a coarse wood-based material. In this case, the peat, compost, or coarse wood-based material also provides the nutrients and organic carbon required. Alternatively, the microorganisms may be provided by including a source of innoculation, which may also a nutrient source, such as, for example, a standard laboratory bacterial growth medium containing microorganisms.

The nutrients in the hydrophobic coating preferably include phosphorus, nitrogen and potassium.

Further, the alkaline buffer in the hydrophobic coating may be selected from the group including silicates, fly ash or similar types of alkaline material.

In another embodiment, there is provided a biofilter media that is operable to remove hydrogen sulfide at a range of pH levels from approximately 2 to approximately 7.

In yet another embodiment, there is provided a biofilter media that is operable to remove hydrogen sulfide within approximately 24 hours of start-up.

According to a further embodiment of the invention, there is provided a biofilter system including a housing, an inlet provided to the housing for receiving contaminated air, an outlet provided to the housing for exhausting cleaned air, and a biofilter media such as that described above situated between the inlet and the outlet through which the contaminated air flows.

In a particular case, the biofilter system further includes a water delivery system for delivering water for irrigation of the biofilter media or steam for the humidification of the contaminated air entering the biofilter system.

According to yet a further embodiment of the invention, there is provided a method of operating a biofilter system, the biofilter system including a housing and a biofilter media, the method including monitoring a temperature of the biofilter media and selectively heating an air stream flowing through the biofilter media or irrigating the biofilter media based on the monitoring to maintain the temperature within a predetermined range. Advantageously, the method above further includes monitoring the air pressure within the housing and selectively heating an air stream flowing through the biofilter media or irrigating the biofilter media based on the pressure monitoring to maintain the pressure within a predetermined pressure range. In particular, the heating of the air stream includes the delivery of steam to the air stream. In another particular case, the irrigation may further include the addition of nutrients, inoculums and alkaline buffers.

It will be understood by one of skill in the art that it may also be advantageous to monitor other characteristics of the biofilter system, such as pH levels and controlling the biofilter system accordingly.

Other aspects and features of the present invention will become apparent to those of ordinary skill in the art upon review of the following description of embodiments of the invention in conjunction with the accompanying figures.

### BRIEF DESCRIPTION OF THE DRAWINGS

The embodiments of the present invention shall be more clearly understood with reference to the following description and to the drawings, in which:

FIG. 1 is a simplified illustration of a biofilter system according to an embodiment of the invention;

FIG. 2 is a conceptual illustration of a grain of a biofilter media according to an embodiment of the invention;

FIG. 3 illustrates the steady state performance of a known biofilter media at 12 ppm average inlet of H₂S;

FIG. 4 illustrates the steady state performance of a known biofilter media at 39 ppm average inlet of H₂S;

FIG. 5 illustrates the performance of a biofilter media according to an embodiment of the invention at a 20 second empty bed resistance time (“EBRT”);

FIG. 6 illustrates the pH profile of biofilter media according to an embodiment of the invention; and

FIG. 7 illustrates the inlet concentration and removal efficiency of a biofilter media according to an embodiment of the invention at 27 seconds EBRT under vacuum.

### DETAILED DESCRIPTION

The Biofilter System

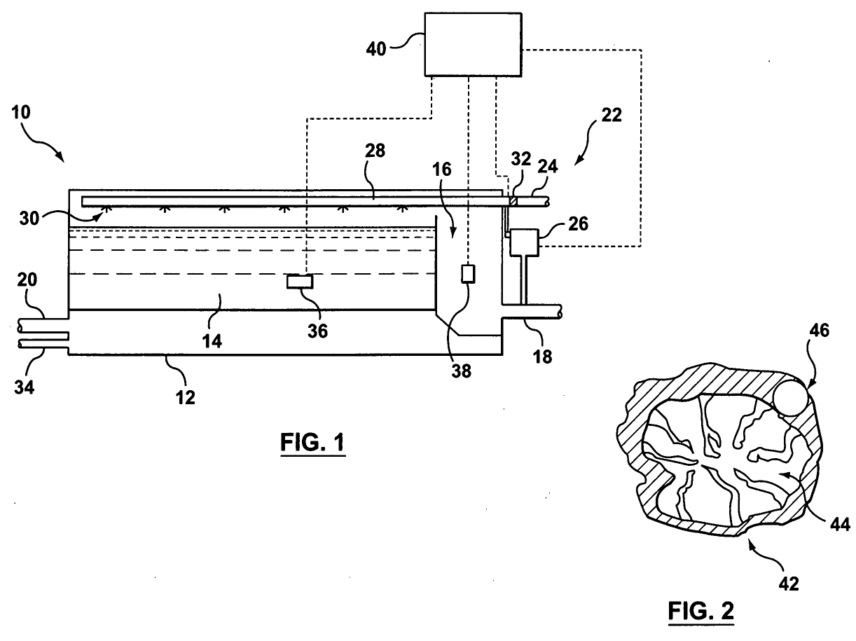

FIG. 1 shows a simplified illustration of a biofilter system 10 according to an embodiment of the invention. The biofilter system 10 includes a housing 12 that houses biofilter media 14. The housing 12 includes a humidification chamber 16 that is positioned adjacent to an inlet 18 by which a contaminated air stream enters the housing 12. The housing 12 also includes an outlet 20 by which a cleaned air stream exits the housing 12. A water supply system 22 is provided to the housing 12 to provide required moisture (water and/or steam) to the biofilter media 14. The water supply system 22 includes a water inlet 24 for the input of water to be used for either steam generation or irrigation of the biofilter media 14. A steam generator 26 may be attached to the inlet 24 for generating steam (when required) and inputting the steam into the inlet 18 or the humidification chamber 16. In addition, attached to the water inlet 24 may be irrigation conduits 28, used to deliver water inside the housing 12. Spray nozzles 30 are provided to the irrigation conduits 28 for spraying water on the biofilter media 14. The water supply system 22 may also include a flow meter 32 to control the amount of water that enters the biofilter system 10 and enters the irrigation conduits 28 for irrigation purposes. The housing 12 further includes a drain line 34 for the removal of excess water and any waste accumulated during the cleansing and irrigation of the biofilter media 14. The biofilter system 10 may also include one or more media temperature sensors 36 (only one sensor shown) that measure the temperature of the biofilter media and one or more pressure sensors 38 (only one sensor shown) that measure the pressure at which air contaminants are flowing through the biofilter media 14. Further, the biofilter system 10 includes a biofilter control system 40 that is in communication with the media temperature sensor 36, the pressure sensor 38, and the water supply system 22 for controlling the biofilter system 10. The temperature of the biofilter media 14 may be controlled by the addition of steam to the contaminated air stream in the inlet 18 or in the humidification chamber 16 or by irrigation of the biofilter media 14 with water. The biofilter system 10 may also have a pH monitoring probe (not shown), for example in the outlet 20 to also be used in monitoring and controlling the operating environment of the biotilter media 14. A more detailed description of a biofilter system can be found in U.S. Pat. No. 5,869,323, the content of which is hereby incorporated herein by reference.

Biofilter Media

Within the biofilter system 10, the biofilter media 14 is provided to remove air contaminants such as organic sulfides and may also remove both chlorinated and non-chlorinated VOC's from contaminated air. FIG. 2 conceptually illustrates a grain 42 of the biofilter media 14 according to an embodiment of the invention. The grains 42 of the biofilter media 14 support the microorganisms that remove the contaminants. Each grain 42 includes a hydrophilic nucleus 44 and a hydrophobic coating 46.

Hydrophilic Nucleus

The hydrophilic nucleus 44 is porous and is formed of a stable, non-reactive, non-flammable, non-toxic and non-odorous material, such as gas concrete, formed clay, pumice and/or aggregates. Preferably the hydrophilic nucleus 44 contains as its primary ingredients silica and alumina, with the balance being made up of such compounds as ferric oxide, calcium oxide, magnesium oxide, sulfur trioxide and alkalis. The preferred ratio of silica to alumina is approximately between 55 and 65% to between 15 and 25% and more preferably around 60% to 20%.

In a particular example, the hydrophilic nucleus 44 may be formed by firing aggregates at a high temperature such as approximately 1100° C., in for example, a rotary kiln (not shown). At this temperature, the minerals present in the aggregates decompose and gases evolve which expand the aggregate making it more porous for higher water retention.

After firing, the expanded porous aggregate is discharged from the rotary kiln into a grate cooler (not shown). The expanded porous aggregate is moistened and then crushed. The crushed aggregate is then screened to grade the particles that are suitable for use as the porous hydrophilic nuclei 44 of each grain 42. The porous hydrophilic nuclei 44 are then mixed with water and the hydrophobic coating 46 is applied by mixing.

Hydrophobic Coating

The hydrophobic coating 46 includes a metallic agent, microorganisms, a bonding agent, nutrients, organic carbon, an alkaline buffer, an adsorptive agent and a hydrophobic agent. The hydrophobic coating 46 may be formed and/or applied in single or multiple stages and may include an appropriate curing period between stages. The final size of each grain of the biofilter media 14 is preferably between approximately 2 and 25 (mm) millimetres.

The nutrients in the hydrophobic coating 46 are preferably a blend of trace elements required for microorganism viability. More particularly, the trace elements preferably include a blend of phosphorus, nitrogen and potassium, as will be known to one of skill in the art. The organic carbon in the hydrophobic coating 46 may be provided by including a natural source such as peat, compost or coarse wood-based material or may be a manufactured source of organic carbon.

The bonding agent in the hydrophobic coating 46 may be an alkaline bonding agent, which bonds the hydrophobic coating 46 to the hydrophilic nucleus 44. As an example, the bonding agent may consist of tricalcium silicate (˜50%), dicalcium silicate (25%), tricalcium aluminate (10%), tetracalcium aluminoferrite (10%), and gypsum (5%). However, one of skill in the art will understand that the composition of the bonding agent may change depending on the application, for example, in the case of higher sulphur loadings, a bonding agent with a lower level of tricalcium aluminate may be used.

The adsorptive agent and the hydrophobic agent may be one or more of activated carbon (a form of inorganic carbon), adsorption resin and/or natural clinoptilolite or clinoptilolite of any form. In a preferred embodiment, some quantity of activated carbon is used because it increases the adsorption of chemicals such as reduced sulphides and aliphatic and aromatic compounds. The use of clinoptilolite is also preferred because the compounds that make up clinoptilolite cause it to have an elevated cation exchange capacity. The cation exchange capacity allows for the altering of the properties of the clinoptilolite in different applications. In addition, clinoptilolite can adsorb gases including hydrogen sulphide, ammonia, mercaptans, formaldehyde, and VOC gases from contaminated air streams. Clinoptilolite also has a large surface area.

Natural clinoptilolite is comprised of approximately 64% silicate, 12% alumina, and various percentages of potassium oxide, calcium oxide, ferric oxide, manganese oxide, titanium oxide and sodium oxide making up the remainder of the composition. A synthetic combination of these substances may also be used.

The metallic agent in the hydrophobic coating 46 is preferably comprised of iron but may also be a similar metal such as manganese, nickel, copper or titanium or some combination thereof. In order to simplify the formation of the hydrophobic coating 46 and ensure an even distribution, the metallic agent may be in powder form. In a particular embodiment, the metallic agent is comprised of iron (66%), silica (3%), alumina (4%), and water (7.5%) and may contain traces of calcium oxide, magnesium oxide, sulfur, copper, phosphorus, and titanium oxide. The presence of iron in the hydrophobic coating 46 allows the removal of sulphur by the formation of iron sulfide (FeS) and serves to enhance the conversion and biological processing of sulfur compounds in the contaminated air. Further, without the presence of iron or metallic components, biological oxidation of sulfur compounds may lead to elemental sulfur deposits on the biofilter media 14.

The quantity of the metallic agent included in the hydrophobic coating 46 can be varied based on an intended life cycle of the biofilter media 14, for example, a life cycle of approximately 10 years. Preferably, the quantity of metallic agent may vary from 2-12 weight percent.

The hydrophobic coating 46 further includes microorganisms such as the bacteria Thiobacillus (T) thioparus, begigiatoa, thiothrix genera, and T. feroxidants, among others. The microorganisms can be supplied to the biofilter media 14 in various ways. Preferrably, the microorganisms are provided by including an organic substrate, which includes microorganisms, an organic carbon source and nutrients for the microorganisms in the preparation of the biofilter media 14. This is often and preferably done by including peat, compost or a coarse wood based material. Preferably, the quantity of peat added may vary from 5-20 weight percent. Alternatively, a mixed culture of inocula grown in a separate bioreactor can be added to the hydrophobic coating 46 in liquid form during the formation of the biofilter media 14 or, alternatively, via the water delivery system 22. The addition of the microorganisms to the biofilter system 22 can be done when needed, including during the operation of the biofilter system 10, if necessary.

As indicated above, the various elements of the hydrophobic coating 46 may be varied depending on the particular application for the biofilter media 14. As an example, preferred ranges for various elements are as follows:
(a) metallic agent 2-12% by weight
(b) peat (microorganisms, organic carbon, nutrients) 5-20%
(c) alkaline buffer/bonding agent 5-10%
(d) adsorptive/hydrophobic agent 2-15%

The process of adding the hydrophobic coating 46 to the hydrophilic nucleus 44 preferably includes an acidification step. Acidification of the hydrophobic coating 46 by phosphoric acid (H₃PO₄) increases both the porosity and the buffering properties of the hydrophobic coating 46 in the finished biofilter media 14. The acidification also acts to greatly increase the surface area and adsorption capacity of the biofilter media 14, allowing for better retention and bonding of air contaminants. Further, the phosphorus from the H₃PO₄ may also act as a nutrient source for microorganism growth.

Operation

Next, the operation of the biofilter system 10 will be described. In operation, the inlet 18 of the biofilter system 10 is connected to an air outlet (not shown) from, for example, a rendering plant. The contaminated air is typically under pressure, either positive or negative, (preferably, approximately −12 to 12 inches of water column), such that it flows through the biofilter media 14.

As the contaminated air flows through the biofilter media 14, contaminants are attracted to the hydrophilic nucleus 44 of the grains 42 and adsorbed physically with the activated carbon where the contaminants interact with the iron or are processed by the microorganisms. The main outputs from the biofilter media 14 are carbon dioxide and water, which are produced during the biological oxidation of VOCs. Where sulfur-based compounds are oxidized, by-products such as SO₃²⁻, SO₄²⁻, S²⁻ or S are generated. These compounds can be easily washed out of the biofilter media 14 with water, using irrigation at pre-determined intervals. As described, the hydrophobic nature of the hydrophobic coating 46 permits excess water to flow through the biofilter media 14 for discharge out the drain line 34, which serves to avoid a build up of sulphur or biomass (that is, too much microorganism growth on the exterior of grains 42) in the biofilter media 14.

With the biofilter media 14 according to this embodiment of the invention, after the biofilter system 10 is put into operation, there is not a lengthy adaptation period or a need to add inocula. The biofilter media 14 start-up is almost immediate and usually in less than a day. The presence of iron (Fe) serves as a catalyst and a chemical reactant to convert sulfur gases to mineral salts during the initial operation. Thereafter, the microorganisms become more active and play a larger role in the processing of the contaminants. This is unlike conventional biofilter systems that may take a few days to become efficient. The presence of iron also helps the biofilter media 14 to handle periods of higher load (shock-loading) by reacting with excess contaminants.

The catalytic properties of both the metallic agent and the hydrophobic coating reduce the adaptation period of the biofilter media as well as the volume of biofilter media required to treat a fixed volume of air contaminant. Lower biofilter media volume in turn permits the installation of much smaller and much less expensive biofilter systems.

The biofilter media 14 removes contaminants from contaminated air and gas effluent under start-up, steady state or transient conditions (due to shock loading in concentrations and/or flow) at an efficient rate. In the event of reduced removal efficiency due to excess loading of contaminants, the activity of the biofilter media 14 can typically be recovered by the addition of a nitrogen source, for example, through the water supply system 22.

Controlling the water content of the biofilter media 14 can be very important. If the biofilter media 14 dries out, the removal of air contaminants, such as sulfur based compounds, will decrease because phase transfer of contaminants from the gas to liquid stage and the biological activity of the microorganisms will be reduced. The embodiment of the grains 42 described herein includes a reservoir of water in the hydrophilic nucleus 44, which sustains transport of the contaminats from gas to liquid phase and supports biological activity throughout the surface area of the biofilter media 14 and aids in keeping the biofilter media 14 from drying out. The hydrophobic coating 46 acts as protection to the hydrophilic nucleus 44 by preventing excess water retention on the surface of the grains 42, which might otherwise cause excess formation of biomass and subsequent resistance to gas flow and, thus, a decrease in the efficiency of the biofilter media.

The water content of the biofilter media 14 in this embodiment is controlled by humidification of the air stream and surface irrigation in the biofilter system 10. Wetting of the biofilter media 14 by the water supply system 22 may make use of water or steam. Humidification of a contaminated air stream occurs in the humidification chamber 16 using, for example pneumatic spray, high-pressure water, steam addition or other technology (not shown). In particular, the addition of steam may be controlled based on the temperature of the air stream, the temperature of the biofilter media 14, climatic conditions and/or heat loss through the biofilter system 10. The biofilter media 14 may also be irrigated by the irrigation conduits 28 and spray nozzles 30. The use of steam in the wetting of the biofilter media 14 can serve to further support the maintenance of the appropriate temperature for optimal functioning of the biofilter media 14.

In operation of the biofilter system 10, the media temperature sensor 36 detects the temperature of the biofilter media 14 and the biofilter control system 40 controls the water supply system 22 to deliver water and/or steam to maintain the biofilter media 14 within a predetermined temperature range. Further, the pressure sensor 38 detects the pressure of the air/gases flowing through the housing 12 and the biofilter control system 40 can adjust the flow of water and/or steam to maintain the pressure within a predetermined range. For example, if the pressure is too high at a particular point across the biofilter media 14 it may be an indication of sulphur build-up. In this case, the biofilter control system 40 may cause the water supply system 22 to irrigate the biofilter media 14 with water to wash away the sulphur build-up. The control system 40 may also monitor the need for and deliver nutrients and pH adjusters to the biofilter media 14. For example, the pH of the biofilter system 10 can be monitored by including a pH monitoring probe (not shown) in the biofilter system 10. If the pH varies outside of the a predetermined range, an appropriate chemical may be added, for example, through the water supply system 22.

The removal kinetics of H₂S using a biofilter media according to an embodiment of the invention have been examined through performance data obtained in an initial pilot study. The biofilter media according to an embodiment of the invention was compared with know biofilter media, BIOSORBENS™, available from Biorem Technologies Inc., Guelph Ontario Canada. The removal kinetics of a biofilter media according to an embodiment of the invention in the initial pilot study follow zero-order diffusion for a given concentration range, while the kinetic correlations closely predict field performance data.

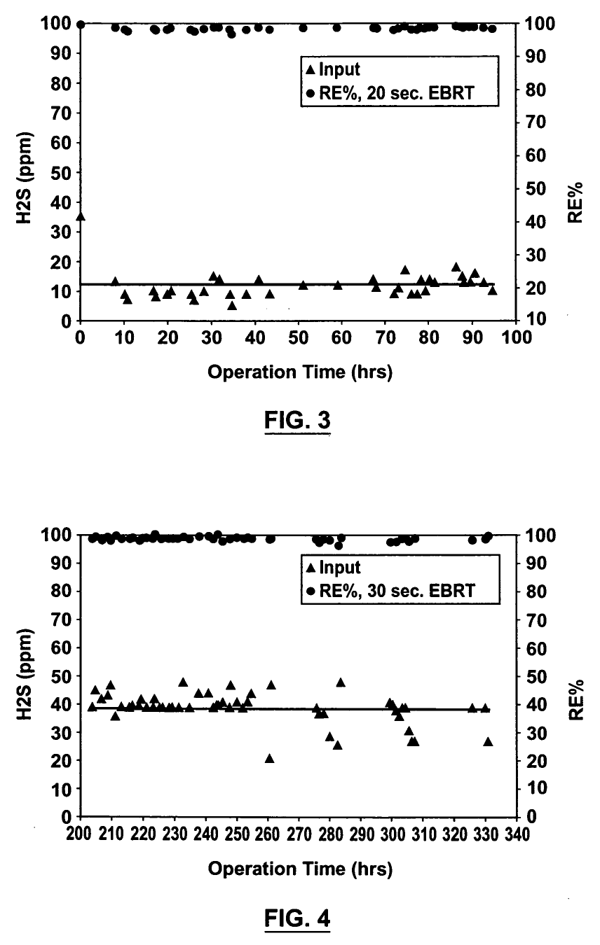

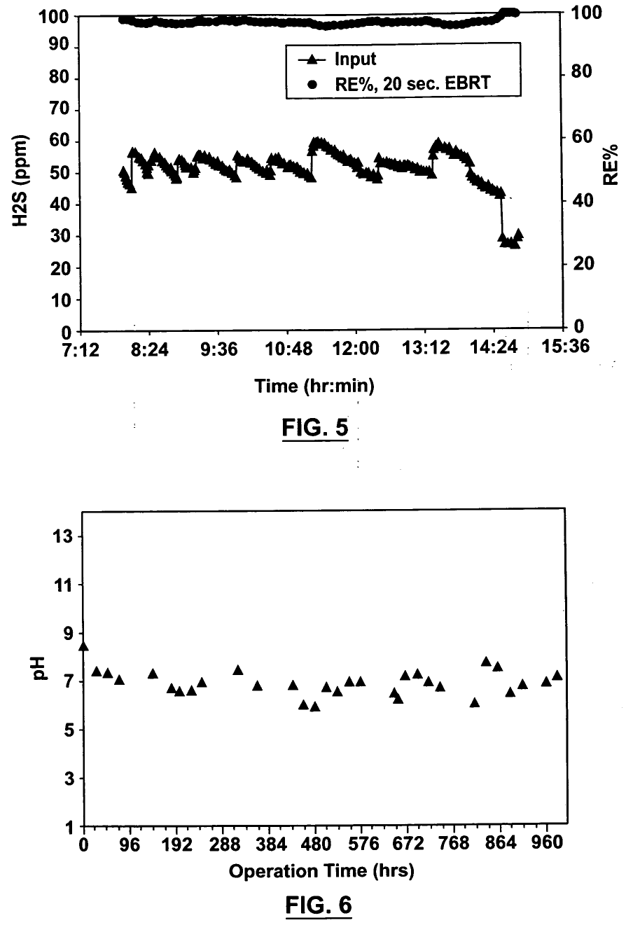

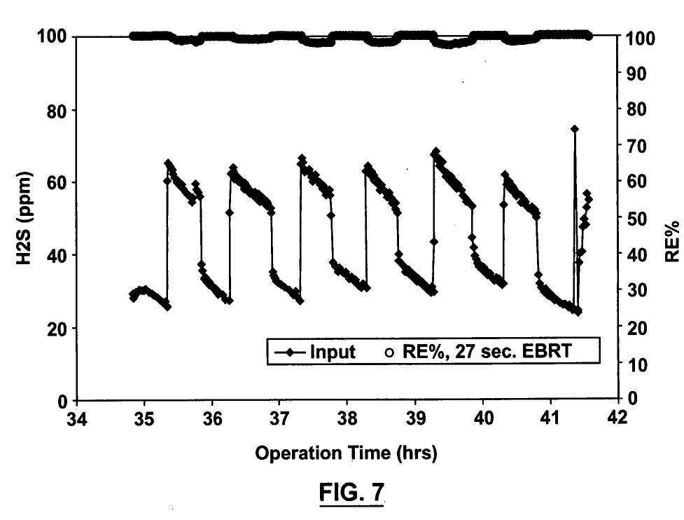

The findings obtained in the initial pilot study include:
i. the biofilter media is able to remove hydrogen sulphide at low (down to approximately ˜2.0) and neutral pH ranges;
ii. the biofilter media has a lower empty bed residence time (“EBRT”) than the known biofilter media, which facilitates the removal of higher concentrations of sulfides at lower EBRT's (See FIGS. 3, 4, and 5);
iii. an approximate neutral pH can be maintained by simple irrigation of the biofilter media without the need of chemical additives (See FIG. 6);
iv. the biofilter media provides uniform performance under cyclic shock loading under negative pressure (See FIG. 7); and
v. the biofilter media can be washed easily to remove by-products of H₂S oxidation.

The removal kinetic constant established through the pilot column experiments with the biofilter media (refer to FIG. 1) has been found to be higher than a value obtained with the known biofilter media BIOSORBENS™. Thus, higher removability of the biofilter media according to an embodiment of the invention provides design options for smaller biofilter systems with very low media volume.

In particular, the biofilter media is effective at removing hydrogen sulphide (H₂S) with and without the presence of volatile organic compounds under neutral pH conditions.

The above described embodiments of the biofilter media have many advantages, including that elements of the biofilter media such as aggregate, metallic agent, and natural clinoptilolite or clinoptilolite in any form, all help increase the rate of reaction and chemical conversion of the air contaminants leaving a sulfide precipitate that can be oxidized by biological oxidation by microorganisms.

The inclusion of a metallic agent and more particularly iron, improves the removal efficiency of air contaminants and nuisance odors, particularly hydrogen sulphide, reduced sulfur compounds and inorganic sulfur along with volatile organic compounds such as those found in industrial facilities, municipal plant facilities and exhaust air streams by increasing the reaction rate of chemical conversion followed by biological oxidation. Intermediate by-products resulting from chemical reactions such as conversion by the metallic agent are easily biodegradable and do not deposit in the biofilter media causing a reduction in the life cycle.

In the biofilter media, the microorganisms generate inert precipitating agents as well as other substances (mainly soluble compounds, elemental sulfur, insoluble salts and/or organic sulfur) that can be removed by oxidation or washed from the biofilter media by irrigation. The solution used in irrigating the biofilter media to remove precipitating agents can be water (without the addition of chemicals) and can be added without causing additional gas flow resistance due to excess biomass formation.

The ability to add water to the biofilter media not only provides a wetting property for the continuation of biological oxidation, but also serves to maintain the proper air and biofilter media temperature for supporting a high rate of metabolism in the bacteria. In order to keep the biofilter media sufficiently warm, steam may be added before the air stream enters the biofilter media.

The aim of the present invention is to provide a more effective and efficient elimination of air contaminants containing sulfur based compounds and VOC's, including those containing chlorinated compounds, which avoids at least some of the drawbacks of conventional biofilters.

In particular, the embodiment of the invention provides a biofilter system and biofilter media that can be used to remove sulfur based compounds and VOC's at a high concentration, high flow rate and variable pH while extending the life span of the biofilter media and decreasing the adaptation period.

The biofilter media according to embodiments of the invention is also more uniform in composition than conventional biofilter media. In addition, due to its composition, the biofilter media according to an embodiment of the invention does not easily compact. Thus, the biofilter media provides less gas flow resistance (low pressure drop) such that energy consumption required for gas flow through the media is lower. These features increase the long-term efficiency and the serviceable life of the biofilter media and therefore, the life span of the biofilter system.

For example, neutral pH can also be maintained by mixing the biofilter media with a pre-determined quantity of limestone particles having a size (2 to 25 mm) equal to that of the grains 42 in the biofilter media 14. Alternatively, a liquid buffer may be added through the water supply system 22. Thus, by adding a liquid buffer or mixing the media with neutralizing solid agents such as limestone, high removal efficiency of reduced sulfur compounds (i.e., di-methyl sulphide) can be maintained in the biofilter media 14. In any event, based on the pilot study, removal of hydrogen sulphide (H₂S) can be easily achieved at neutral (˜7.0) and also at low pH levels (˜2.0).

Byproducts generated due to oxidation of contaminants/ and or reactive products resulting from addition of neutralizing agents in the biofilter media 14 can be easily washed out with irrigation water without any chemical addition.

Depending on the particular application for the biofilter system, the biofilter media can be placed in enclosed modular or in ground biofilter systems which are operated under positive or negative pressure with or without covers.

It will be further understood that the invention is not limited to the embodiments described herein which, are merely illustrative of preferred embodiments of carrying out the invention, and which are susceptible to modification of form, arrangement of parts, steps, details and order of operation. The invention, rather, is intended to encompass all such modification within its scope, as defined by the claims.

1. A biofilter media comprising a plurality of grains, each grain comprising:
a porous hydrophilic nucleus; and
a hydrophobic coating on said hydrophilic nucleus, wherein said hydrophobic coating comprises:
a metallic agent;
microorganisms;
nutrients;
organic carbon;
an alkaline buffer;
a bonding agent;
an adsorptive agent; and
a hydrophobic agent.

2. A biofilter media according to claim 1, wherein said hydrophilic nucleus comprises porous low-density aggregate.

3. A biofilter media according to claim 2, wherein said porous low density aggregate is produced by gas expansion at temperatures exceeding 1100° C.

4. A biofilter media according to claim 1, wherein said metallic agent comprises at least one metal selected form the group of iron, manganese, nickel, copper, titanium or a similar metal from the transition element group having similar properties.

5. A biofilter media according to claim 1, wherein said metallic agent comprises iron.

6. A biofilter media according to claim 1, wherein said metallic agent is in powdered form prior to formation of said hydrophobic coating.

7. A biofilter media according to claim 1, wherein said adsorptive agent and said hydrophobic agent comprise clinoptilolite.

8. A biofilter media according to claim 7, wherein said adsorptive agent and said hydrophobic agent further comprise activated carbon.

9. A biofilter media according to claim 1, wherein said microorganisms are provided by including a source of innoculation.

10. A biofilter media according to claim 1, wherein said microorganisms comprise microorganisms selected from Thiobacillus (T) thioparus, begigiatoa, thiothrix genera, and T. feroxidants.

11. A biofilter media according to claim 1, wherein said microorganisms, nutrients and organic carbon are provided by one or more of peat, compost or a coarse wood-based material.

12. A biofilter media according to claim 1, wherein said nutrients comprise phosphorus, nitrogen and potassium.

13. A biofilter media according to claim 9, wherein said source of inoculation comprises microorganisms and a nutrient source.

14. A biofilter media according to claim 9, wherein said source of inoculation is a standard laboratory bacterial growth medium containing microorganisms.

15. A biofilter media according to claim 14, wherein said standard laboratory bacterial growth medium is agar or broth.

16. A biofilter media according to claim 1, wherein said alkaline buffer may be selected from the group comprising silicates, fly ash or similar alkaline material.

17. A biofilter media according to claim 1, wherein each said grain has a size of approximately between 2 and 25 (mm) millimeters.

18. A biofilter media according to claim 1, which is operable to remove hydrogen sulfide at a range of pH levels from approximately 2 to approximately 7.

19. A biofilter media according to claim 1, which is operable to remove hydrogen sulfide within approximately 24 hours of start-up.

20. A biofilter system comprising:
a housing;
an inlet provided to said housing for receiving contaminated air;
an outlet provided to said housing for exhausting cleaned air; and
a biofilter media situated between said inlet and said outlet through which said contaminated air flows, wherein said biofilter media comprises:
a porous hydrophilic nucleus; and
a hydrophobic coating on said hydrophilic nucleus, wherein said hydrophobic coating comprises:
a metallic agent;
microorganisms;
nutrients;
an organic carbon source;
alkaline buffer;
a bonding agent;
an adsorptive agent; and
a hydrophobic agent.

21. A biofilter system according to claim 18, further including a water delivery system.

22. A method of operating a biofilter system, said biofilter system comprising a housing and a biofilter media, said method comprising:
monitoring a temperature of said biofilter media;
selectively heating an air stream flowing through said biofilter media or irrigating said biofilter media based on said monitoring to maintain said temperature within a predetermined range.

23. A method of operating a biofilter system according to claim 22, further comprising:
monitoring air pressure within said housing; and
selectively heating an air stream flowing through said biofilter media or irrigating said biofilter media based on said pressure monitoring to maintain said pressure within a predetermined pressure range.

24. A method of operating a biofilter system according to claim 22, wherein said heating of said air stream comprises delivering steam to said air stream.

25. A method of operating a biofilter system according to claim 22, wherein said irrigation further comprises the addition of nutrients, inoculums and alkaline buffers.
